(19) United States
(12) Patent Application Publication
(10) Pub. No.: US 2012/0094506 A1
(43) Pub. Date: Apr. 19, 2012

(54) SOCKET AND MOTHERBOARD WITH THE SAME

(76) Inventor: Tung-Ke LU, Taipei (TW)

(21) Appl. No.: 12/906,621

(22) Filed: Oct. 18, 2010

(51) Int. Cl. H01R 12/73

(52) U.S. Cl. 439/61; 439/59

(57) ABSTRACT

A socket for selectively mounting on a board includes a housing and a latch. The housing includes a first side plate and a second side plate parallel to the first side plate. The first and second side plates define an elongated slot therebetween for reception of the board. The latch includes an axle, a body and a fastening portion. The axle is pivotably coupled to the housing at one end of the slot. The body has one end joined to the axle and the other end to the fastening portion. The fastening portion is constructed for engagement with the board. In addition, the lateral width of the body of the latch in the direction along the width of the first side plate is smaller than that of the axle in the same direction.

### BACKGROUND OF INVENTION

1. Field of Invention

The present invention relates to a socket and a motherboard using the socket, and in particular to a latch structure of the socket.

2. Related Prior Art

Electrical sockets for mounting a plurality of circuit board cards on a motherboard are well known in the industry. The circuit board cards may be interface cards, adapter cards or other types of circuit board, such as single in-line memory modules (SIMM) or dual inline memory modules (DIMM). The circuit board cards may also be test boards or other types of board with specific functions. In order to ensure that the circuit board cards are maintained in position in the sockets and well electrically engaging with contacts of the sockets, a number of latches are provided on ends of the sockets.

A conventional motherboard, prior to that patent, is equipped with a number of memory sockets that are arranged side by side and spaced apart on the circuit board. In doing so, gaps between each two memory sockets are unused and become a waste of the motherboard. For this, some techniques are provided to solve the forgoing problems as following.

With the miniaturization of the electronic devices, dimensions of the circuit boards installed in the electronic devices are confined more or less. The electronic devices may be desktop computers, laptop computers, server computers or the like. Due to the tight space limits, the conventional server motherboard 9, as shown in FIG. 7, has its memory sockets 90 divided into two groups side by side along a longitudinal direction. Further, the three memory sockets 90 in each group are arranged side by side along a lateral direction and spaced apart from one another. Besides, each of the three memory sockets 90 in one group is oriented end to end and in close proximity to the respective one in the other group.

As shown in FIG. 8, each of the two memory socket 901 on the motherboard 9 has an end formed with a latch 901. The latch 901 can be held in a latched position, as shown in FIG. 8, for fastening a circuit board card (not shown), or be pulled to an open position, as shown in FIG. 9, for extraction of the circuit board card.

However, it is necessary for the motherboard 9 to preserve an interval W between the two adjacent memory sockets 90 in order to allow the opposed latches 901 of the memory sockets 90 to be completely pulled to the respective open positions, as shown in FIG. 9. The interval W apparently occupies an area of the motherboard 9 and is undesired in the motherboard where space is at a premium.

### SUMMARY OF INVENTION

It is an object of the invention to provide a socket to improve the space utilization of a motherboard. The socket includes a housing and a first latch. The housing includes a first side plate and a second side plate. The first and second side plates are parallel to each other and co-define an elongated slot therebetween for reception of a board. The first latch includes a first axle, a first body and a first fastening portion. The first axle is pivotably coupled to the housing at one end of the slot. The first body has one end joined to the first axle and the other end to the first fastening portion. The first fastening portion is constructed for engagement with the board. In particular, the lateral width of the first body of the first latch in the direction along the width the first side plate of the housing is smaller than that of the first axle in the same direction.

Preferably, the socket further includes a second latch having a second axle, a second body and a second fastening portion. The second latch is pivotably coupled to the housing at the other end of the slot. The second body has one end joined to the second axle and the other end to the second fastening portion. The second fastening portion is constructed for engagement with the board. In addition, the lateral width of the second body of the second latch in the direction along the width the second side plate of the housing is smaller than that of the second axle in the same direction.

The first body and second body are staggered in position so that the two sockets can be arranged end to end on a circuit board and put as closer as required, and thereby save space and maximize the space utilization of the circuit board.

It is another object of the invention to provide a motherboard using at least two aforementioned sockets. The motherboard includes a circuit board, a first socket and a second socket. The first and second sockets are arranged end to end on the circuit board and both use to the aforementioned socket in structure.

Further, since the first and second sockets are identical in structure, the injection mould cost for making the sockets can be reduced and the sockets can be assembled on the motherboard in a more convenient way.

Further features and advantages of the present invention will be appreciated by review of the following detailed description of the invention.

### BRIEF DESCRIPTION OF DRAWINGS

The invention will now be described by way of example with reference to the accompanying drawings wherein:

FIG. 1 is a perspective view of a socket in accordance with one embodiment of the invention;

FIG. 2 is a top view of the socket in FIG. 1;

FIG. 3 illustrates that a board is seated in the socket of FIG. 1;

FIG. 4 is a view similar to FIG. 3, illustrating that the latches at the ends of the socket are in latched positions;

FIG. 5 illustrates that two sockets are arranged end to end on a circuit board with the adjacent latches in the open positions;

FIG. 6 is a view similar to FIG. 5, illustrating that the adjacent latches of the two sockets are in the latched positions;

FIG. 7 is top view of a prior art motherboard;

FIG. 8 is a perspective view of two prior art sockets with end latches in latched positions; and

FIG. 9 is a view similar to FIG. 8, illustrating that the end latches of the prior art sockets are in open positions.

### DETAILED DESCRIPTION OF EMBODIMENTS

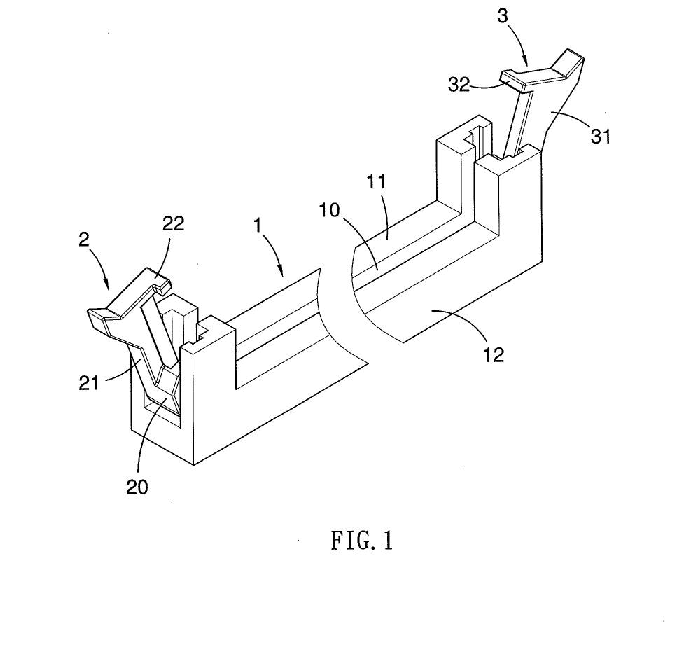

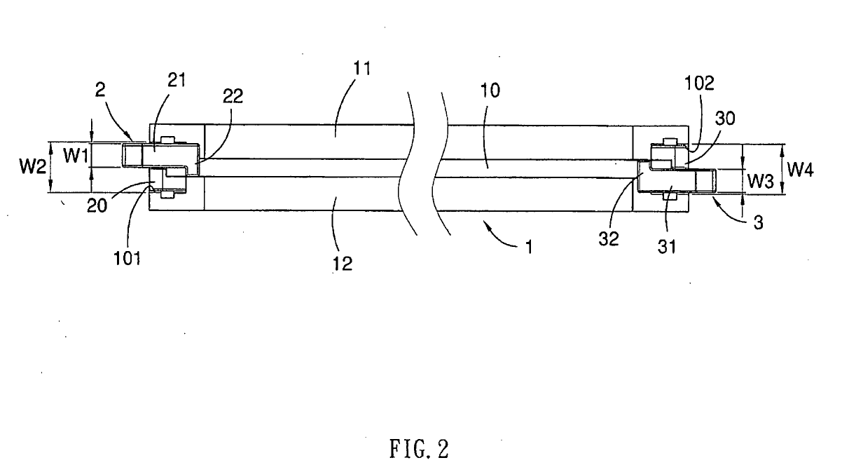

Referring now to FIGS. 1 and 2, a socket in accordance with one embodiment of the invention includes a housing 1, a first latch 2 and a second latch 3.

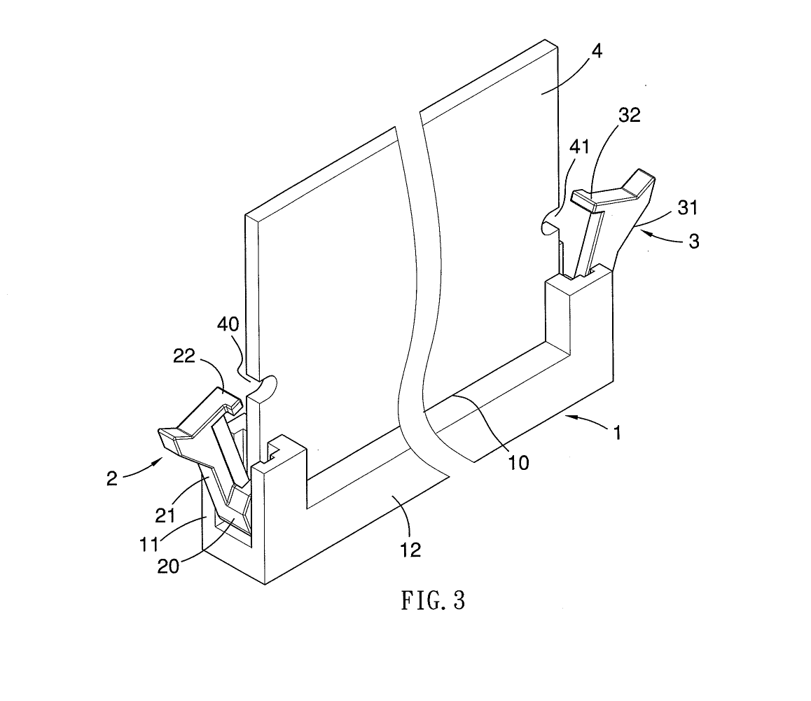

The housing 1 includes a first side plate 11 and a second side plate 12. The first side plate 11 and second side plates 12 are parallel to each other and co-define an elongated slot 10 therebetween for reception of a board 4 (FIG. 3).

As shown in FIG. 1, the first latch 2 includes a first axle 20, a first body 21 and a first fastening portion 22. The first axle 20 is pivotably coupled to the housing 1 at one end of the slot 10. The first body 21 has its lower end joined to the first axle 20 and the upper end to the first fastening portion 22. Moreover, the lateral width of the first body 21 of the first latch 2 in the direction along the width of the first side plate 11 is smaller than that of the first axle 20 from the same direction. The first fastening portion 22 is constructed for engagement with one end of the board 4. In this embodiment, the first fastening portion 22 is, but not limited to, a protrusion or a latching projection extending from the first body 21 to enhance engagement with the board 4.

FIG. 2 is a top view of the socket in FIG. 1. As can be seen in FIG. 2, the second latch 3 includes a second axle 30, a second body 31 and a second fastening portion 32. The second axle 30 is pivotably coupled to the housing 1 at the other end of the slot 10. Similar to the first body 21, the second body 31 has its lower end joined to the second axle 30 and the upper end to the second fastening portion 32. Moreover, the lateral width of the second body 31 of the second latch 3 in the direction along the width of the second side plate 12 is smaller than that of the second axle 30 in the same direction. The second fastening portion 32 is constructed for engagement with the other end of the board 4. In this embodiment, the second fastening portion 32 is, but not limited to, a protrusion or a latching projection extending from the second body 31 to enhance engagement with the board 4.

FIG. 3 illustrates that the board 4 is seated in the socket, and the first body 21 and second body 31 are rotated about the respective first axle 20 and second axles 30 to the open positions. The board 4 has an edge portion received in the slot 10 of the housing 1 of the socket. The board 4 may be an interface card, an adapter card, a dual inline memory module (DIMM) or other types of circuit board card, or even just a dummy board with no electrical traces printed thereon. In this embodiment, the board 4 is a dual inline memory module with a first notch 40 and a second notch 41 at opposite ends thereof, and the socket is a specialized DIMM socket for the board 4. The first fastening portion 22 and the second fastening portion 32 of the socket are configured to be engaged in the first notch 40 and the second notch 41 of the board 4. FIG. 3 illustrates that the first fastening portions 22 and second fastening portion 32 are detached away from the corresponding 40 and notch 41 of the board 4 to release the board 4.

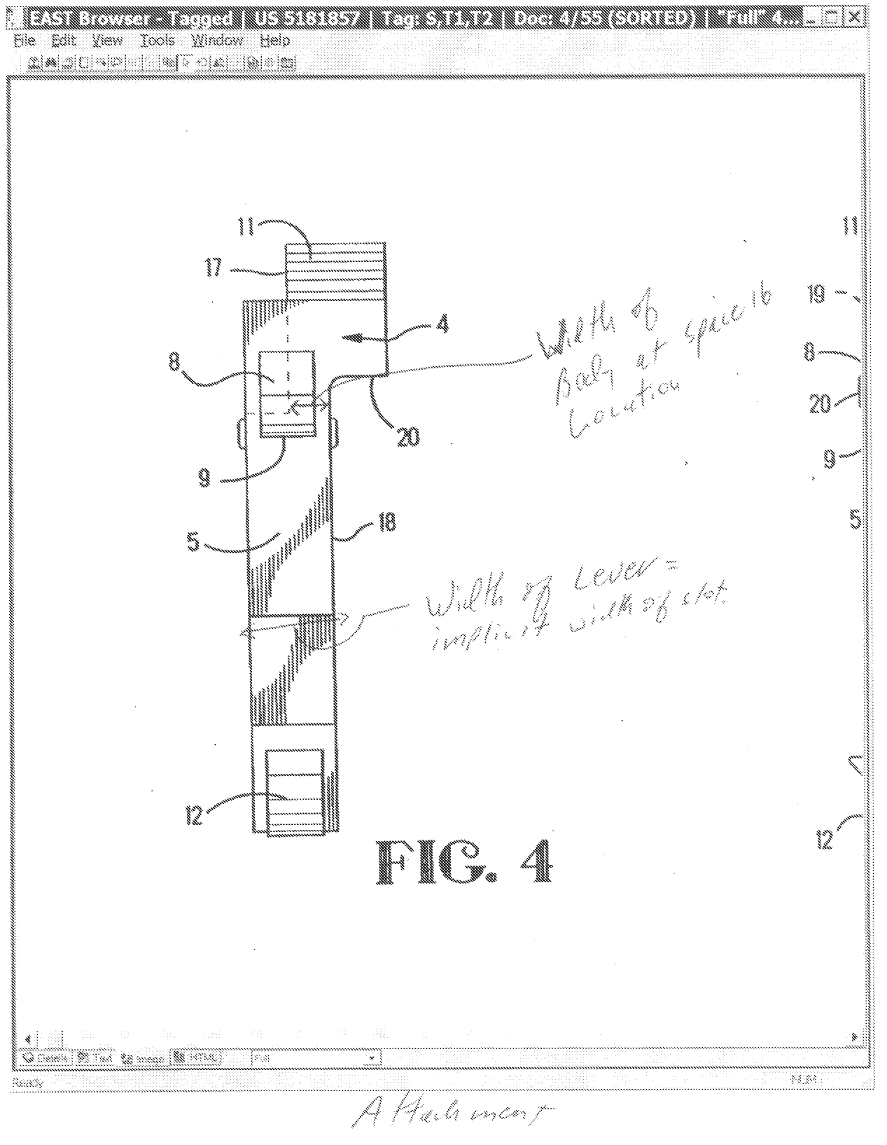

In contrast, FIG. 4 illustrates that the board 4 is seated in the socket while the first body 21 and the second body 31 are rotated to the closed or latched positions. At this time, the first fastening portion 22 and second fastening portions 32 of the socket are engaged in the first notch 40 and the second notche 41 of the board 4 respectively, and therefore the board 4 is securely seated in the socket and is not allowed to be extracted from the socket.

In particular, since the lateral width of the first body 21 from the first side plate 11 is smaller than that of the first axle 20 from the first side plate 11 and also the lateral width of the second body 31 from the second side plate 12 is smaller than that of the second axle 30 from the second side plate 12, the first and second bodys 21, 31 of the socket are staggered in position. In doing so, two aforementioned sockets can be arranged end to end on a circuit board to save space, as will be discussed later.

In concerned with the injection mould cost, the first and second latches 2, 3 may be identical to each other in structure. On the other hand, the socket may be equipped with only one latch, either the first latch 2 or the second latch 3, rather than two latches so as to keep the cost down further.

In this embodiment, the lateral width of the first body 21 in the direction along the width of the first side plate 11 equals one half of that of the first axle 20 in the same direction; and also the lateral width of the second body 31 in the direction along the width of the second side plate 12 equals one half of that of the second axle 30 in the same direction.

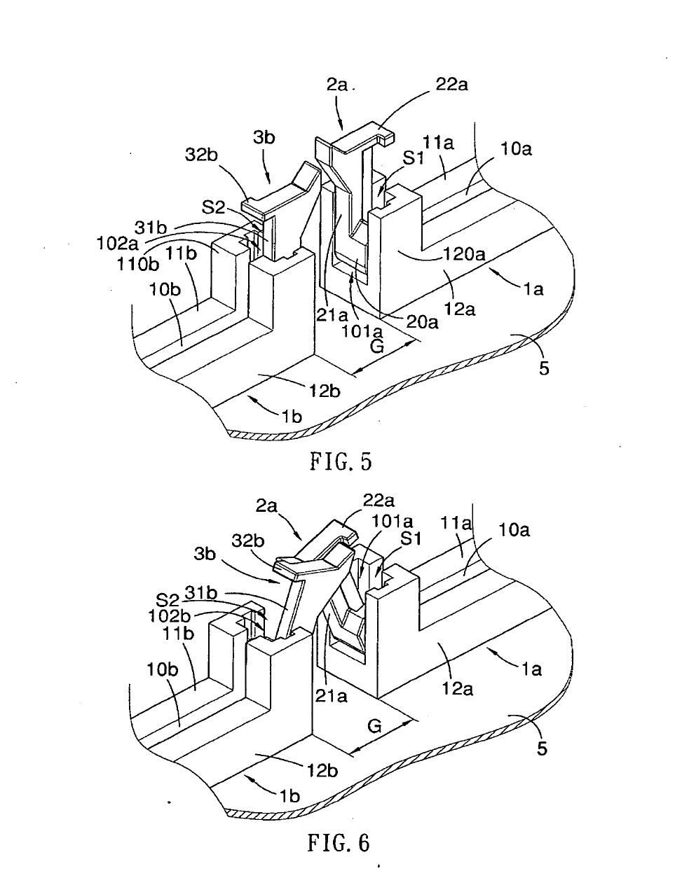

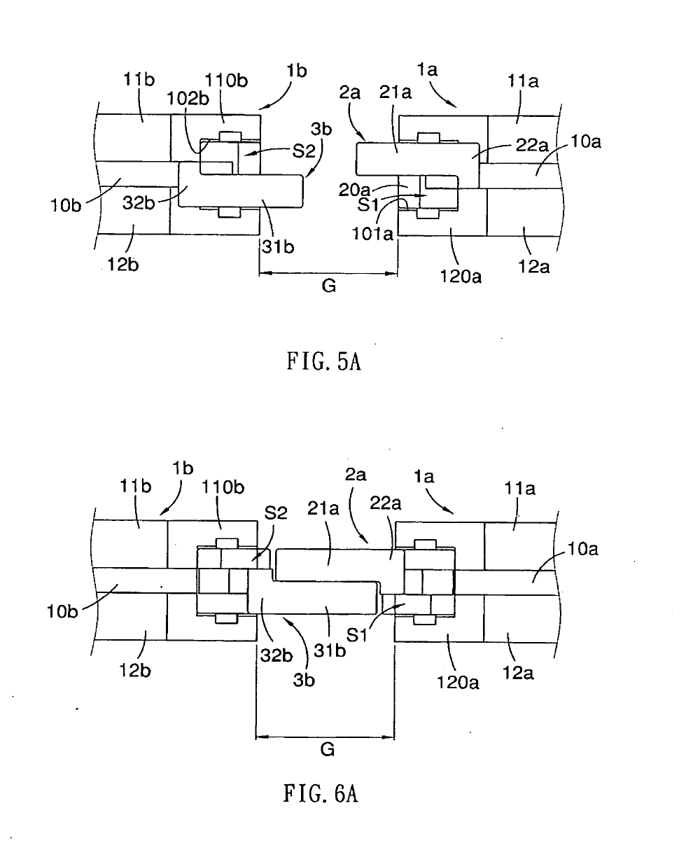

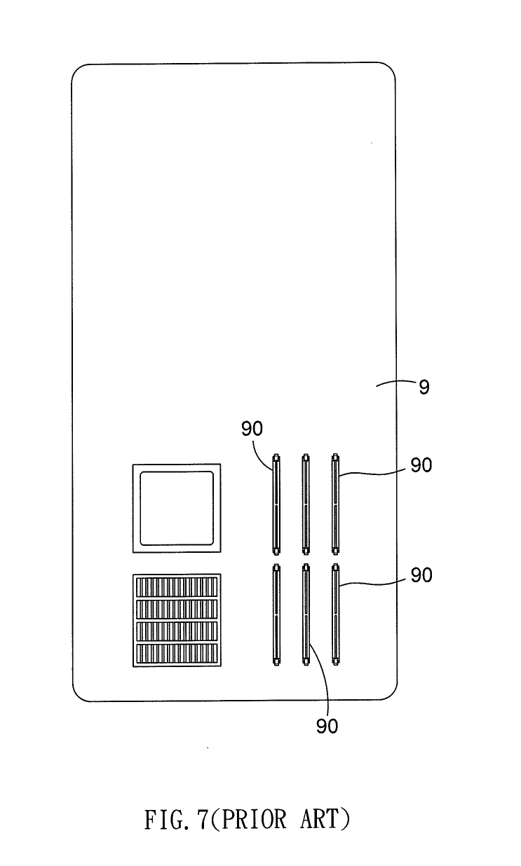

With reference to FIG. 5, a motherboard in accordance with one embodiment of the invention includes a circuit board 5, a first socket and a second socket. The first and second sockets are similar to the aforementioned socket. Specifically, the first socket includes a first housing 1a and a first latch 2a. The second socket includes a second housing 1b and a second latch 3b. For clarity, only partial portions of the sockets are depicted in FIG. 5.

The first housing 1a of the first socket includes a first side plate 11a and a second side plate 12a parallel to the first side plate 11a. The first and second side plates 11a, 11b define a first elongated slot 10a therebetween for reception of a first board (not shown). On the other hand, the first latch 2a of the first socket includes a first axle 20a, a first body 21a and a first fastening portion 22a. The first axle 21a is pivotably coupled to the first housing 1a at one end of the first elongated slot 10a. , The first body 21a has its lower end joined to the first axle 21a and the upper end to the first fastening portion 22a. Similar to the first fastening portion 22 of FIG. 1, the first fastening portion 22a is constructed for engagement with the first board. Substantially all of the features on the first fastening portion 22 of FIG. 1 apply to the first fastening portion 22a and will not be discussed further herein. In this embodiment, the first fastening portion 22a is, but not limited to, a protrusion or a latching projection extending from the first body 21a.

The second housing 1b of the second socket includes a third side plate 11b and a fourth side plate 12b parallel to the third side plate 11b. The third side plate 11b and the fourth side plate 12b define a second elongated slot 10b therebetween for reception of a second board (not shown). On the other hand, the second latch 3b of the second socket includes a second axle (not shown, but similar to the second axle 30 of FIG. 2), a second body 31b and a second fastening portion 32b. The second axle 31b is pivotably coupled to the second housing 1b at one end of the second elongated slot 10b. The second body 31b has its lower end joined to the second axle and the upper end to the second fastening portion 32b. The second fastening portion 32b is constructed for engagement with the second board. Substantially all of the features on the second fastening portion 32 of FIG. 1 apply to the second fastening portion 32a and will not be discussed further herein. In this embodiment, the second fastening portion 32a is, but not limited to, a protrusion or a latching projection extending from the second body 31a.

Similarly, the first latch 2a and second latches 3a may be identical to each other in structure in concerned with the injection mould cost. Preferably, the lateral width of the first body 21a of the first latch 2a in the direction along the width of the first side plate 11a equals one half of the distance between the first side plate 11a and second side plate 12b. In addition, the lateral width of the second body 31b of the second latch 3b from the fourth side plate 12b of the second housing 1b equals one half of the distance between the third and fourth side plates 11b, 12b.

It should be noted that the first and second latches are not limited to specific configuration as disclosed above, but may be formed in other types of construction as long as they are staggered. For example, the lateral width of the first body may equal two third of the distance between the first and second side plates and the lateral width of the second body may equal one third of the distance between the third and fourth side plates such that the first and second bodies are staggered and will not be blocked by each other when the first and second latches are pulled to the open positions. Alternatively, the first body may be formed of two branches, and the second body, staggered with respect to the branches of the first body, can pass through the tunnel defined between the two branches of the first body while the first and second latches are pulled to the open positions.

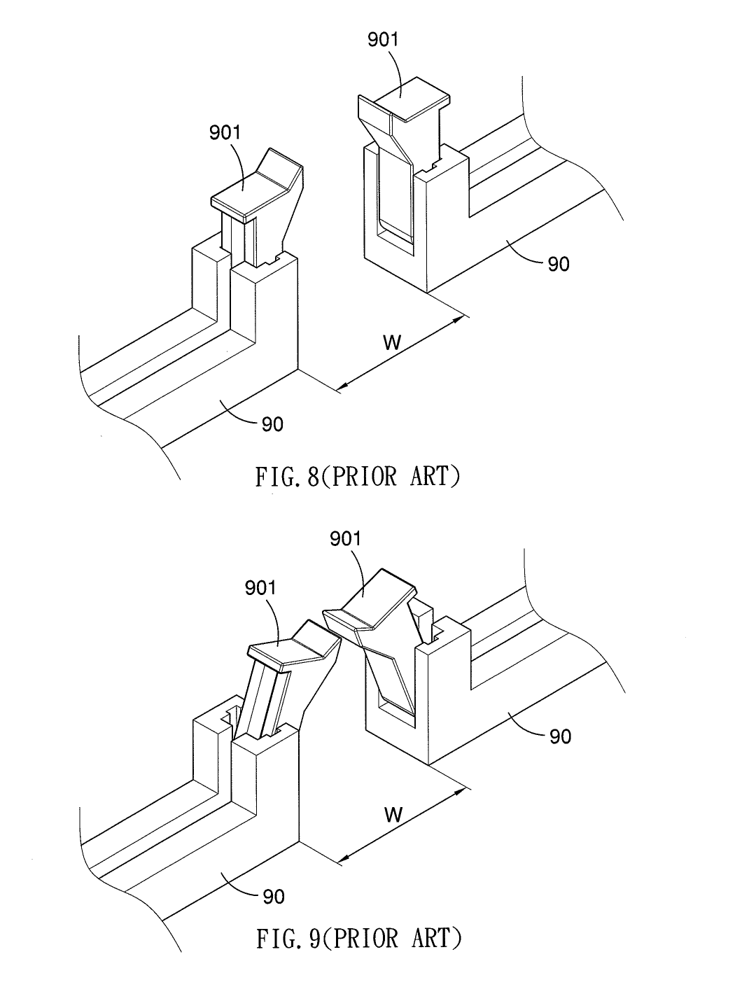

As shown in FIG. 5, the first body 21a of the first socket and the second body 31b of the second socket are disposed in the latched positions. Specifically, the first axle 20a of the first socket is aligned with the second axle of the second socket. The first body 21a of the first socket, proximal to the first side plate 11a, is aligned with a space defined by the second body 31b and the third side plate 11b of the second socket. In contrast, the second body 31b of the second socket, proximal to the fourth side plate 12b, is aligned with a space defined by the first body 21a and the second side plate 12a of the first socket. As a result, the first body 21a of the first socket and the second body 31b of the second socket are staggered and will not be blocked by each other from moving to the open positions, as shown in FIG. 6. In such a manner, the gap G is quite small in comparison with the interval W in FIG. 8 or 9. In other words, the gap between first housing la and the second housing 1b can be reduced or even brought down to zero if required, and thereby maximum the space utilization of the circuit board.

It will be appreciated that although a particular embodiment of the invention has been shown and described, modifications may be made. It is intended in the claims to cover such modifications which come within the spirit and scope of the invention.

1. A socket selectively mounting a board therein, comprising:
a housing including a first side plate and a second side plate parallel to the first side plate; the first plate and the second side plate together defining an elongated slot therebetween for reception of the board and an enlarged end opening at one end of the slot; and
a first latch including a first axle, a first body and a first fastening portion; the first axle received in the end o enin of the housin and ivotably coupled to the housing; the first body having one end joined to the first axle and the other end to the first fastening portion; the first fastening portion constructed for engagement with the board;
wherein the lateral width of the first body of the first latch in a direction along the width of the first side plate is smaller than that of the end opening of the housing in the direction.

2. The socket of claim 1 further comprising a second latch, the second latch including a second axle, a second body and a second fastening portion; the second latch pivotably coupled to the housing and received in an enlarged end opening defined by the first and second side plates of the housing at the other end of the slot; the second body having one end joined to the second axle and the other end to the second fastening portion; the second fastening portion constructed for engagement with the board;
wherein the lateral width of the second body of the second latch in the direction is smaller than that of the other end opening of the housing in the direction.

3. The socket of claim 1, wherein the first fastening portion of the first latch is a protrusion extending from the first body.

4. The socket of claim 2, wherein the first fastening portion of the first latch is a latching projection extending from the first body, and the second fastening portion of the second latch is a protrusion extending from the second body.

5. The socket of claim 2, wherein the lateral width of the first body of the first latch in the direction is half of that of the end opening of the housing in the direction; and the lateral width of the second body of the second latch in the direction is half of that of the other end opening of the housing in the direction.

6. The socket of claim 5, wherein the first and second latches are identical.

7. A motherboard selectively mounting a first board and a second board thereon, comprising:
a first socket including a first housing and a first latch; the first housing including a first side plate and a second side plate parallel to the first side plate; the first and second side plates together defining a first elongated slot therebetween for reception of the first board and an enlarged end opening at one end of the first slot; and the first latch including a first axle, a first body and a first fastening portion; the first axle received in the end opening of the first housing and pivotably coupled to the first housing; the first body having one end joined to the first axle and the other end to the first fastening portion; the lateral width of the first body of the first latch in a direction along the width of the first side plate is smaller than that of the end opening of the first housing in the direction; and the first fastening portion constructed for engagement with the first board; and
a second socket including a second housing and a second latch; the second housing including a third side plate and a fourth side plate parallel to the third side plate; the third and fourth side plates together defining a second elongated slot therebetween for reception of the second board and an enlarged end opening at one end of the second slot; and the second latch including a second axle, a second body and a second fastening portion; the second axle received in the end opening of the second housing and pivotably coupled to the second housing; the second body having one end joined to the second axle and the other end to the second fastening portion; the lateral width of the second body of the second latch in a direction along the width of the third side plate is smaller than that of the end opening of the second housing in the direction; and the second fastening portion constructed for engagement with the second board;
wherein the first socket and the second socket are arranged end to end; the first body of the first latch of the first socket is aligned with a space of the end opening of the second housing defined among the second axle, the second body and an end portion of the third side plate of the second socket; and the second body of the second latch of the second socket is aligned with a space of the end opening of the first housing defined among the first axle, the first body and an end portion of the second side plate of the first socket.

8. The motherboard of claim 7, wherein the first fastening portion of the first latch is a protrusion extending from the first body, and the second fastening portion of the second latch is a protrusion extending from the second body.

9. The motherboard of claim 7, wherein the lateral width of the first body of the first latch of the first socket in a direction along the width of the first side plate equals half of the lateral width of the end opening of the first housing; and the lateral width of the second body of the second latch of the second socket in the direction equals half of the lateral width of the end opening of the second housing.

10. The motherboard of claim 9, wherein the first latch of the first socket and the second latch of the second socket are identical.

11. The socket of claim 2, wherein the total lateral width of the first body of the first latch and the second body of the second latch equals the lateral width of the either end opening of the housing.

12. A motherboard selectively mounting a first board and a second board thereon, comprising:
a first socket including a first housing and a first latch; the first housing including a first side plate and a second side plate parallel to the first side plate; the first and second side plates together defining a first elongated slot therebetween for reception of the first board and an enlarged end opening at one end of the first slot; and the first latch including a first axle, a first body and a first fastening portion; the first axle received in the end opening of the first housing and pivotably coupled to the first housing ; the first body having one end joined to the first axle and the other end to the first fastening portion; the first fastening portion constructed for engagement with the first board; and
a second socket including a second housing and a second latch; the second housing including a third side plate and a fourth side plate parallel to the third side plate; the third and fourth side plates together defining a second elongated slot therebetween for reception of the second board and an enlarged end opening at one end of the second slot; and the second latch including a second axle, a second body and a second fastening portion; the second axle received in the end opening of the second housing and pivotably coupled to the second housing; the second body having one end joined to the second axle and the other end to the second fastening portion; the second fastening portion constructed for engagement with the second board;
wherein the first socket and the second socket are arranged end to end; and the total lateral width of the first body of the first latch of the first socket and the second body of the second latch of the second socket equals the lateral width of the end opening of the first or second housing.
